(19) United States
(12) Patent Application Publication
(10) Pub. No.: US 2012/0238303 A1
(43) Pub. Date: Sep. 20, 2012

(54) RADIO COMMUNICATION SYSTEM, BASE SATION APPARATUS, TERMINAL APPARATUS, AND RADIO COMMUNICATION METHOD

(75) Inventors: Tatsuya Kikuzuki, Kawasaki (JP); Yoji Ohashi, Fucyu (JP); Kaoru Yokoo, Yokosuka (JP)

(73) Assignee: FUJITSU LIMITED, Kawasaki-shi (JP)

(21) Appl. No.: 13/417,614

(22) Filed: Mar. 12, 2012

(30) Foreign Application Priority Data
Mar. 14, 2011 (JP) 2011-055372

(51) Int. Cl. H04W 72/12; H04W 88/02; H04W 88/08

(52) U.S. Cl. 455/509; 455/561; 455/550.1

(57) ABSTRACT

A radio communication system including a base station apparatus including a first memory to store a schedule for communication using each of a plurality of set values of a predetermined communication element in the physical layer, a first antenna to communicate with a terminal apparatus using a first set value of the plurality of set values in accordance with the schedule stored in the first memory, and a first processor to select a second set value of the plurality of set values if the condition of communication performed with the terminal apparatus by the first antenna using the first set value has deteriorated, and cause the first antenna to perform communication using the selected second set value in accordance with the schedule and the terminal apparatus including a second memory to store the schedule, a second antenna to communicate with the base station apparatus, and a second processor.

### CROSS-REFERENCE TO RELATED APPLICATION

This application is based upon and claims the benefit of priority of the prior Japanese Patent Application No. 2011-55372, filed on Mar. 14, 2011, the entire contents of which are incorporated herein by reference.

### FIELD

The embodiments discussed herein are related to a radio communication system, a base station apparatus, a terminal apparatus, and a radio communication method.

### BACKGROUND

In recent years, in medical and healthcare fields, a body area network (BAN) has attracted attention as a technique for measuring biological information. The BAN enables radio communication in which terminal apparatuses worn on human bodies are used within a communication range in and around the human bodies. The BAN allows communication in which it is possible to switch the setting of a communication element used, at the physical layer (PHY), between devices of the same type. Examples of the communication element used at the PHY include frequency. Hereinafter, a communication element used at the PHY will be simply referred to as “PHY”.

For radio communication where different PHYs can be used, some techniques are known in which the communication condition that has deteriorated can be improved by switching one PHY in use to another.

For example, Japanese Laid-open Patent Publication No. 9-205393 discloses a technique in which, if communication is lost, a base station and a terminal apparatus sequentially switch the frequency used in the communication from one value to another to resume the communication. In this technique, if communication using a frequency is lost, the base station and the terminal apparatus sequentially switch the frequency from one value to another to identify a frequency at which communication is possible. Thus, the base station and the terminal apparatus are synchronized and resume the communication at the identified frequency.

Japanese Laid-Open Patent Publication No. 6-85794 discloses a technique which uses a carrier-frequency switching request signal when the communication condition deteriorates. In this technique, when the condition of communication using a frequency deteriorates, a base station continuously transmits a carrier-frequency switching request signal using the same frequency currently used until confirming that the carrier-frequency switching request signal has been received by a terminal apparatus. Upon completion of the transmission, the base station switches the frequency used at the PHY to a frequency specified by the carrier-frequency switching request. The terminal apparatus also switches the frequency used at the PHY to the frequency specified by the carrier-frequency switching request. This resumes the communication between the base station and the terminal apparatus.

### SUMMARY

According to an aspect of the invention, a radio communication system including a base station apparatus including a first memory configured to store a schedule for communication using each of a plurality of set values of a predetermined communication element in the physical layer, a first antenna configured to communicate with a terminal apparatus using a first set value of the plurality of set values in accordance with the schedule stored in the first memory, and a first processor configured to select a second set value of the plurality of set values if the condition of communication performed with the terminal apparatus by the first antenna using the first set value has deteriorated, and cause the first antenna to perform communication using the selected second set value in accordance with the schedule and the terminal apparatus including a second memory configured to store the schedule, a second antenna configured to communicate with the base station apparatus using the first set value in accordance with the schedule stored in the second memory, and a second processor configured to select the second set value if the condition of communication performed with the base station apparatus by the second antenna using the first set value has deteriorated, and cause the second antenna to perform communication using the selected second set value in accordance with the schedule.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an overall view of a radio communication system;

FIG. 2 is a block diagram of a base station apparatus according to a first embodiment;

FIG. 3 is a block diagram of a terminal apparatus according to the first embodiment;

FIG. 4 is a flowchart of a PHY switching process in the base station apparatus according to the first embodiment;

FIG. 5 is a flowchart of a PHY switching process in the terminal apparatus according to the first embodiment;

FIG. 6 illustrates PHY switching in a radio communication system according to the first embodiment;

FIG. 7 is a flowchart of a PHY switching process in a base station apparatus according to a second embodiment;

FIG. 8 illustrates PHY switching in a radio communication system according to the second embodiment;

FIG. 9 illustrates a hardware configuration of a base station apparatus; and

FIG. 10 illustrates a hardware configuration of a terminal apparatus.

### DESCRIPTION OF EMBODIMENTS

In the technique disclosed in Japanese Laid-open Patent Publication No. 9-205393 in which communication lost is resumed by sequentially switching a frequency from one value to another, the length of time during which one communication station operates at one frequency is set to be longer than a period for completion of all frequency switching operations at another communication station. Therefore, if the length of time allocated to each frequency in the period of frequency switching is long, or if the number of frequencies at which communication can be resumed is small, it may take a long time to achieve a frequency match and may be difficult to resume the communication in a short time. Moreover, the power consumption may increase, because attempts to establish a communication connection are continuously made until the communication is resumed.

In the technique disclosed in Japanese Laid-Open Patent Publication No. 6-85794 in which a carrier-frequency switching request signal is used, the transmission of the carrier-frequency switching request signal is attempted using a frequency at which the communication condition has deteriorated. Thus, since the carrier-frequency switching request signal may not be properly received, it may be difficult to reliably resume the communication. Even if the communication can be resumed, it may take time to receive the carrier-frequency switching request signal and hence it is difficult to resume the communication in a short time. Again, the power consumption may increase, because attempts to establish a communication connection are continuously made until the carrier-frequency switching request signal is properly received.

A technique to be disclosed below has been made in view of the circumstances described above, and aims to provide a radio communication system, a base station apparatus, a terminal apparatus, and a radio communication method that can resume communication in a short time while reducing power consumption.

Embodiments of a radio communication system, a base station apparatus, a terminal apparatus, and a radio communication method disclosed in the present application will now be described in detail with reference to the drawings. Note that the radio communication system, the base station apparatus, the terminal apparatus, and the radio communication method disclosed in the present application are not limited to the following embodiments.

### First Embodiment

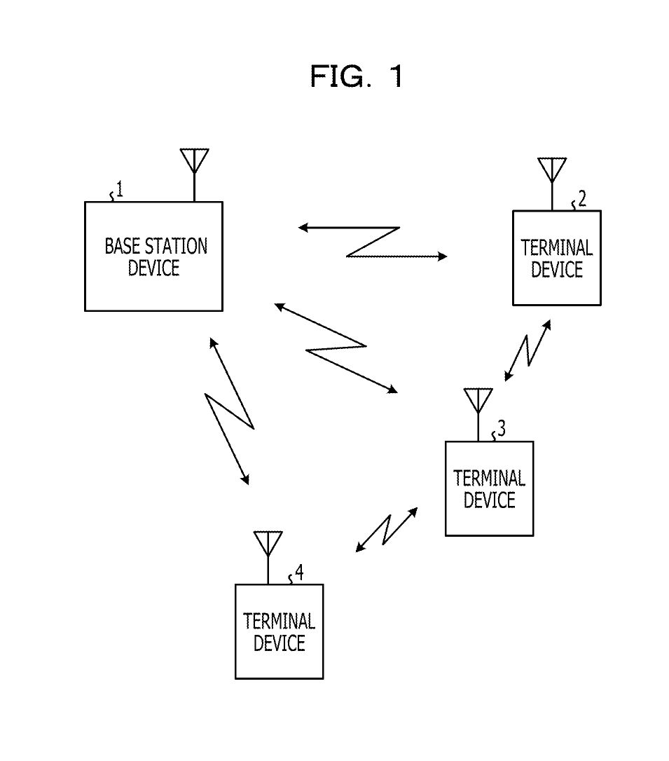

FIG. 1 is an overall view of a radio communication system. As illustrated in FIG. 1, a radio communication system according to a first embodiment includes a base station apparatus 1 and terminal apparatuses 2, 3, and 4. The base station apparatus 1 and each of the terminal apparatuses 2 to 4 can communicate with each other. Communication between each of the terminal apparatuses 2 to 4 is also possible. In the first embodiment, the terminal apparatuses 2 to 4 have the same configuration. Therefore, in the following description, the terminal apparatus 2 will be described as an example. Hereinafter, a communication element used at the physical layer, such as a frequency, will be simply referred to as “PHY”.

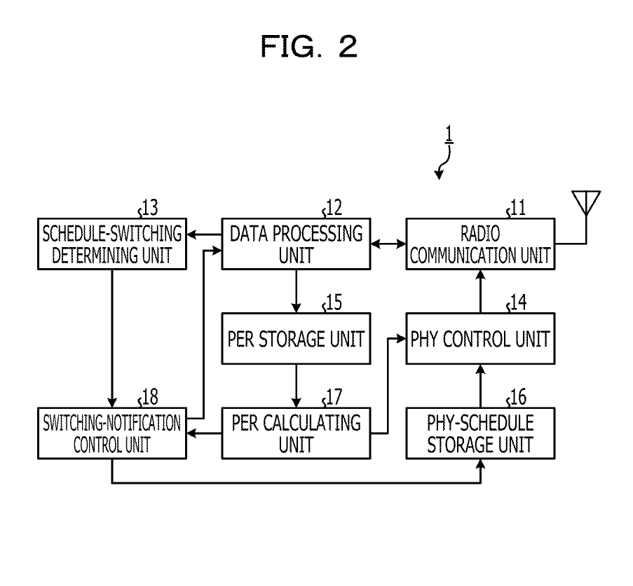

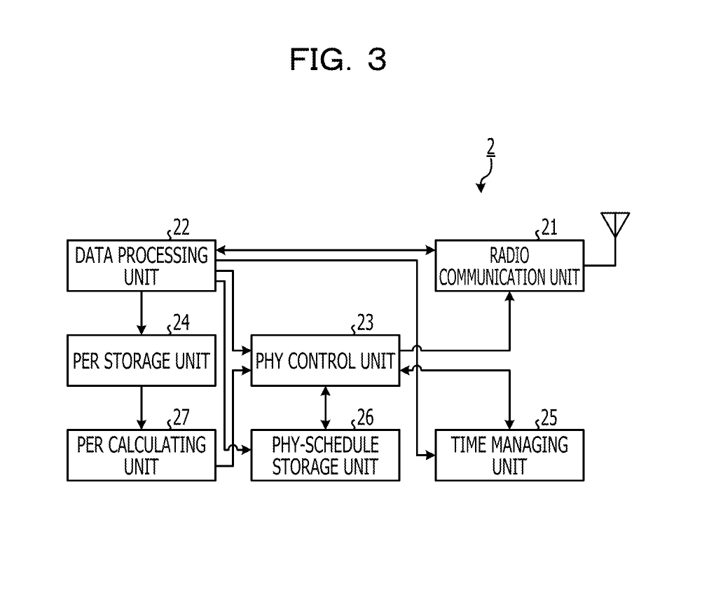

FIG. 2 is a block diagram of the base station apparatus 1 according to the first embodiment. FIG. 3 is a block diagram of the terminal apparatus 2 according to the first embodiment.

As illustrated in FIG. 2, the base station apparatus 1 according to the first embodiment includes a radio communication unit 11, a data processing unit 12, a schedule-switching determining unit 13, a PHY control unit 14, a packet error rate (PER) storage unit 15, a PHY-schedule storage unit 16, a PER calculating unit 17, and a switching-notification control unit 18.

The PHY-schedule storage unit 16 stores a schedule for communication using each of PHYs (hereinafter may be simply referred to as a “PHY schedule”). The PHY schedule is a schedule time-multiplexed for each of PHYs to be used. In other words, the PHY schedule allocates a communication period to each of PHYs. In the first embodiment, PHYs 1 to 3 are used as PHYs. In this case, a period of communication using PHY 1, a period of communication using PHY 2, and a period of communication using PHY 3 are allocated in the PHY schedule. The PHY-schedule storage unit 16 is an example of “first schedule storage unit”. The PHY schedule is an example of “schedule for communication using each of a plurality of set values of a predetermined communication element in the physical layer”.

The length of a period during which communication is performed using one PHY can be determined, for example, to be equivalent to the length of a superframe in the radio communication system.

To start communicating with the terminal apparatus 2, the radio communication unit 11 receives, from the PHY control unit 14, input of information on a predetermined PHY and the start and end timing of communication using the predetermined PHY. Here, PHY 1 will be described as the predetermined PHY. The predetermined PHY is an example of “first set value”. The radio communication unit 11 makes communication settings such that communication using PHY 1 can be performed in accordance with the start and end timing of communication using PHY 1.

If the PER calculating unit 17 determines that the condition of communication with the terminal apparatus 2 has deteriorated, the radio communication unit 11 receives, from the PHY control unit 14, input of information on another PHY to be used after switching. The radio communication unit 11 also receives, from the PHY control unit 14, input of the start and end timing of communication using the PHY to be used after switching. Here, PHY 2 will be described as the PHY to be used after switching. The radio communication unit 11 makes communication settings such that communication using PHY 2 can be performed in accordance with the start and end timing of communication using PHY 2. The PHY specified by the PHY control unit 14 as a PHY to be used after switching when the PER calculating unit 17 determines that the condition of communication with the terminal apparatus 2 has deteriorated is an example of “second set value”.

In accordance with the start and end timing of communication using the PHY specified by the PHY control unit 14, a radio signal is transmitted from the terminal apparatus 2 through an antenna to the radio communication unit 11. The radio communication unit 11 receives the radio signal by using the PHY. From the radio signal received, the radio communication unit 11 generates a baseband signal and outputs the generated baseband signal to the data processing unit 12.

Also, the radio communication unit 11 receives input of a baseband signal generated by the data processing unit 12.

The radio communication unit 11 converts the baseband signal received from the data processing unit 12 to a radio signal which corresponds to the PHY specified by the PHY control unit 14. In accordance with a schedule for communication using the PHY specified by the PHY control unit 14, the radio communication unit 11 transmits the radio signal to the terminal apparatus 2 by using the PHY.

If the switching-notification control unit 18 determines that the terminal apparatus 2 is in communication with one or both of the terminal apparatuses 3 and 4, the radio communication unit 11 receives input of a PHY switching notification packet from the data processing unit 12. At the same time, also from the data processing unit 12, the radio communication unit 11 receives input of information on the terminal apparatus (or devices) with which the terminal apparatus 2 is in communication. Then, the radio communication unit 11 converts the PHY switching notification packet to a radio signal and transmits the radio signal to the terminal apparatus (or devices) with which the terminal apparatus 2 is in communication.

When the PHY schedule is to be changed, the radio communication unit 11 receives input of a schedule change notification packet from the data processing unit 12. The radio communication unit 11 converts the schedule change notification packet to a radio signal and transmits the radio signal to the terminal apparatus 2. The radio communication unit 11 is an example of “first radio communication unit”.

From the radio communication unit 11, the data processing unit 12 receives input of a baseband signal generated from a signal received from the terminal apparatus 2. Then, the data processing unit 12 performs baseband processing, such as demodulation and error correction decoding, on the received baseband signal. The data processing unit 12 provides an operator with the baseband-processed signal. At the same time, the data processing unit 12 error-checks the baseband-processed signal and determines, from the check result, whether the signal transmitted from the terminal apparatus 2 has been properly received. The data processing unit 12 then stores the result of the determination in the PER storage unit 15.

From the signal received from the terminal apparatus 2, the data processing unit 12 obtains various types of information indicating the condition of communication with the terminal apparatus 2. The data processing unit 12 outputs the obtained information indicating the condition of communication to the schedule-switching determining unit 13. For example, from the signal received from the terminal apparatus 2, the data processing unit 12 determines the amount of data per unit time to calculate the throughput of the terminal apparatus 2. Then, the data processing unit 12 outputs information on the calculated throughput of the terminal apparatus 2 to the schedule-switching determining unit 13.

The data processing unit 12 performs modulation on data or voice input from an external device, and generates a baseband signal. At the start of communication with the terminal apparatus 2, the data processing unit 12 adds a packet for synchronization to the generated baseband signal. The packet for synchronization contains information for notification of scheduled timing of a PHY switching period. The data processing unit 12 outputs the generated baseband signal to the radio communication unit 11.

From the switching-notification control unit 18, the data processing unit 12 receives input of a PHY switching notification packet (described below) and information on the terminal apparatus (or devices) with which the terminal apparatus 2 is in communication. Then, the data processing unit 12 performs modulation on the received PHY switching notification packet to generate a baseband signal. The data processing unit 12 outputs, to the radio communication unit 11, the PHY switching notification packet converted to the baseband signal and the information on the terminal apparatus (or devices) with which the terminal apparatus 2 is in communication.

When the PHY schedule is to be changed, the data processing unit 12 receives input of a schedule change notification packet (described below) from the switching-notification control unit 18. Then, the data processing unit 12 performs modulation on the received schedule change notification packet to generate a baseband signal. The data processing unit 12 outputs, to the radio communication unit 11, the schedule change notification packet converted to the baseband signal. The data processing unit 12 is an example of “schedule transmitting unit”.

The schedule-switching determining unit 13 stores a condition for determining whether a schedule for communication with the terminal apparatus 2 is to be changed (hereinafter, this condition will be referred to as a “change condition”). From the data processing unit 12, the schedule-switching determining unit 13 receives input of information indicating the condition of communication with the terminal apparatus 2. From the information received, the schedule-switching determining unit 13 determines whether the condition of communication with the terminal apparatus 2 satisfies the change condition. If determining that the condition of communication with the terminal apparatus 2 satisfies the change condition, the schedule-switching determining unit 13 notifies the switching-notification control unit 18 to change the schedule in accordance with the change condition. For example, the schedule-switching determining unit 13 stores, as a change condition, a threshold value S for the throughput of the terminal apparatus 2. From the data processing unit 12, the schedule-switching determining unit 13 receives input of information on the throughput of the terminal apparatus 2. Then, the schedule-switching determining unit 13 determines whether the throughput of the terminal apparatus 2 is below the threshold value S. If the throughput of the terminal apparatus 2 is below the threshold value S, the schedule-switching determining unit 13 determines that a period during which no communication is performed (hereinafter may be referred to as “inactive period”) is too long. If determining that the inactive period is too long, the schedule-switching determining unit 13 notifies the switching-notification control unit 18 to shorten the inactive period.

In the first embodiment, a decrease in throughput is used as a change condition for changing the PHY schedule. However, any other condition may be used, as long as it can be used to determine whether to switch the set value in the PHY setting. For example, if the occurrence of data delay is too frequent in the terminal apparatus 2, or if a period during which there is no communication with the terminal apparatus 2 is too long, a period for the PHY used by the terminal apparatus 2 may be shortened. In this case, a schedule for communication using the PHY used by the terminal apparatus 2 may be determined in accordance with the timing of occurrence of data for the terminal apparatus 2. However, a schedule change notification packet (described below) used for schedule change is not directly related to actual transmission and reception of data. Therefore, it is preferable that the number of schedule change notification packets be minimized to reduce system load and power consumption.

In the first embodiment, a schedule change is made to improve communication efficiency by using an appropriate schedule. However, even if there is no schedule change function, it is possible to realize PHY switching with low power consumption.

The PER storage unit 15 is a storage device, such as a memory. From the data processing unit 12, the PER storage unit 15 receives a result of determination as to whether a signal transmitted from the terminal apparatus 2 has been properly received. The PER storage unit 15 stores the received result of determination, along with the time of receipt.

The PER calculating unit 17 stores a threshold value M1 for the number of signals received in the past T1 seconds, and a threshold value M2 for the number of signals actually received out of N1 signals scheduled to be received. The PER calculating unit 17 also stores a signal reception schedule in which, for example, one signal is scheduled to be received every 30 minutes. The PER calculating unit 17 is equipped with a clock.

From the result of determination stored in the PER storage unit 15 as described above, the PER calculating unit 17 obtains, at predetermined intervals, the number of signals properly received in the past T1 seconds and the number of properly received signals corresponding to N1 signals scheduled to be received. Then, the PER calculating unit 17 determines whether the number of signals properly received in the past T1 seconds is less than or equal to the threshold value M1. The PER calculating unit 17 also determines whether the number of properly received signals corresponding to the N1 signals scheduled to be received is less than or equal to the threshold value M2. If the number of signals properly received in the past T1 seconds is less than or equal to the threshold value M1, or if the number of properly received signals corresponding to the N1 signals scheduled to be received is less than or equal to the threshold value M2, the PER calculating unit 17 determines that the PER has deteriorated. This determination is equivalent to determining whether the number of received signals determined to be abnormal is greater than or equal to a threshold value. In other words, the PER calculating unit 17 determines whether the PER is greater than or equal to a predetermined threshold value.

If determining that the PER has deteriorated, the PER calculating unit 17 notifies the PHY control unit 14 that PHY switching is to be performed. Also, the PER calculating unit 17 instructs the switching-notification control unit 18 to transmit a PHY switching notification packet. The switching-notification control unit 18 receives, from the schedule-switching determining unit 13, a notification of change of a PHY schedule and changes to be made to the PHY schedule. Then, the switching-notification control unit 18 changes the PHY schedule stored in the PHY-schedule storage unit 16 to reflect the changes. For example, if the switching-notification control unit 18 is instructed to shorten an inactive period, the switching-notification control unit 18 shortens the inactive period by a predetermined length of time and extends the period of communication using each PHY by the same length of time. Then, the switching-notification control unit 18 creates a schedule change notification packet which contains information on the changed PHY schedule. The switching-notification control unit 18 outputs the created schedule change notification packet to the data processing unit 12. The function of PHY schedule switching performed by the schedule-switching determining unit 13 and the switching-notification control unit 18 is an example of “schedule switching unit”.

The switching-notification control unit 18 stores the order of use of PHYs in advance. If there are PHY 1 to PHY 3, the switching-notification control unit 18 stores the order which indicates, for example, that PHY 1 is to be used first, PHY 2 is to be used second, and PHY 3 is to be used third. The switching-notification control unit 18 receives, from the PER calculating unit 17, an instruction to transmit a PHY switching notification packet. Then, the switching-notification control unit 18 creates a PHY switching notification packet which contains information on a PHY to be used next, and outputs the created PHY switching notification packet to the data processing unit 12.

The switching-notification control unit 18 stores information in advance as to whether there is communication between the terminal apparatus 2 and another terminal apparatus. For switching a PHY used for the terminal apparatus 2, the switching-notification control unit 18 identifies a terminal apparatus which is in communication with the terminal apparatus 2. Then, the switching-notification control unit 18 notifies the data processing unit 12 to transmit the PHY switching notification packet also to the identified terminal apparatus. Thus, even when the PHY used in the communication with the terminal apparatus 2 is changed, the terminal apparatus 2 can continue to communicate with another terminal apparatus with which the terminal apparatus 2 has been in communication. The switching-notification control unit 18 is an example of “switching notification unit”.

The PHY control unit 14 stores the order of use of PHYs in advance. If there are PHY 1 to PHY 3, the PHY control unit 14 stores the order which indicates, for example, that PHY 1 is to be used first, PHY 2 is to be used second, and PHY 3 is to be used third.

When the radio communication unit 11 starts communicating with a terminal apparatus, the PHY control unit 14 obtains, from the PHY schedule stored in the PHY-schedule storage unit 16, a schedule for communication using PHY 1 which is placed first in the order of use. The schedule for communication is, for example, the start and end timing of the communication. Then, the PHY control unit 14 transmits the schedule for PHY 1 and information on PHY 1 to the radio communication unit 11.

When the condition of communication using PHY 1 deteriorates, the PHY control unit 14 receives a PHY switching notification from the PER calculating unit 17. Then, the PHY control unit 14 identifies a PHY which is placed, in the order or use, after the PHY currently in use. Here, PHY 1 is the PHY currently in use, and PHY 2 is the PHY placed after PHY 1 in the order of use. From the PHY schedule stored in the PHY-schedule storage unit 16, the PHY control unit 14 obtains a schedule for communication using PHY 2. The PHY control unit 14 outputs information on PHY 2, which is a PHY to be used next, and the schedule for communication using PHY 2 to the radio communication unit 11.

Here, information on the PHY to be used in communication and the schedule for communication using the PHY only are output from the PHY control unit 14 to the radio communication unit 11. For example, when two PHYs are to be used in communication, the PHY control unit 14 outputs information on the two PHYs and schedules for communication using the two PHYs to the radio communication unit 11. More specifically, assume that there is a change in communication from a state in which the terminal apparatus 3 and the terminal apparatus 2 are in communication with the base station apparatus 1 using PHY 1 to a state in which the terminal apparatus 2 and the base station apparatus 1 are in communication using PHY 2. In this case, the base station apparatus 1 still continues to communicate with the terminal apparatus 3 using PHY 1. Therefore, the PHY control unit 14 outputs information on PHY 1 and PHY 2 and schedules for communication using PHY 1 and PHY 2 to the radio communication unit 11. Thus, the radio communication unit 11 sets the communication condition for only the periods allocated to the PHYs to be used, and this can reduce power consumption. The PHY control unit 14 is an example of “first set value switching unit”.

The terminal apparatus 2 according to the first embodiment will now be described. As illustrated in FIG. 3, the terminal apparatus 2 according to the first embodiment includes a radio communication unit 21, a data processing unit 22, a PHY control unit 23, a PER storage unit 24, a time managing unit 25, a PHY-schedule storage unit 26, and a PER calculating unit 27.

To start communicating with the base station apparatus 1, the radio communication unit 21 receives, from the PHY control unit 23, input of information on a predetermined PHY and the start and end timing of communication using the predetermined PHY. Here, PHY 1 will be described as the predetermined PHY. The predetermined PHY is an example of “first set value”. The radio communication unit 21 makes communication settings such that communication using PHY 1 is performed in accordance with the start and end timing of communication using PHY 1.

If the PER calculating unit 27 determines that the condition of communication with the base station apparatus 1 has deteriorated, or if a PHY switching notification packet is transmitted from the base station apparatus 1, the radio communication unit 21 receives, from the PHY control unit 23, input of information on a PHY to be used after switching. Also from the PHY control unit 23, the radio communication unit 21 receives input of the start and end timing of communication using the PHY to be used after switching. Here, PHY 2 will be described as the PHY to be used after switching. The radio communication unit 21 makes communication settings such that communication using PHY 2 can be performed during the start to end of the period allocated to PHY 2. PHY 2, which is a PHY specified by the PHY control unit 23 to be used after switching, is an example of “second set value”.

In accordance with the start and end timing of communication using the PHY specified by the PHY control unit 23, a radio signal is transmitted from the base station apparatus 1 through an antenna to the radio communication unit 21. The radio communication unit 21 receives the radio signal by using the PHY. From the radio signal received, the radio communication unit 21 generates a baseband signal and outputs the generated baseband signal to the data processing unit 22.

The radio communication unit 21 receives a PHY switching notification packet from the base station apparatus 1. The radio communication unit 21 converts the PHY switching notification packet to a baseband signal and outputs the baseband signal to the data processing unit 22.

Also, the radio communication unit 21 receives input of a baseband signal generated by the data processing unit 22.

The radio communication unit 21 converts the baseband signal received from the data processing unit 22 to a radio signal which corresponds to the PHY specified by the PHY control unit 23. In accordance with a schedule for communication using the PHY specified by the PHY control unit 23, the radio communication unit 21 transmits the radio signal to the base station apparatus 1 by using the PHY. The radio communication unit 21 is an example of “second radio communication unit”.

From the radio communication unit 21, the data processing unit 22 receives input of a baseband signal generated from a signal received from the base station apparatus 1. Then, the data processing unit 22 performs baseband processing, such as demodulation and error correction decoding, on the received baseband signal. The data processing unit 22 provides an operator with the baseband-processed signal. At the same time, the data processing unit 22 error-checks the baseband-processed signal and determines, from the check result, whether the signal transmitted from the base station apparatus 1 has been properly received. The data processing unit 22 then stores the result of the determination in the PER storage unit 24.

The data processing unit 22 receives a schedule change notification packet from the base station apparatus 1 through the antenna and the radio communication unit 21. The data processing unit 22 obtains a changed PHY schedule from the schedule change notification packet. Then, the data processing unit 22 stores the changed PHY schedule in the PHY-schedule storage unit 26.

The data processing unit 22 receives input of a PHY switching notification packet from the radio communication unit 21. The data processing unit 22 then outputs, to the PHY control unit 23, a request for switching to a PHY specified by the PHY switching notification packet.

The data processing unit 22 performs modulation on data or voice input by the operator, and generates a baseband signal. Then, the data processing unit 22 outputs the generated baseband signal to the radio communication unit 21.

The PER storage unit 24 is a storage device, such as a memory. From the data processing unit 22, the PER storage unit 24 receives a result of determination as to whether a signal transmitted from the base station apparatus 1 has been properly received. The PER storage unit 24 stores the received result of determination, along with the time of receipt.

The PER calculating unit 27 stores a threshold value M3 for the number of signals received in the past T2 seconds, and a threshold value M4 for the number of signals actually received out of N2 signals scheduled to be received. The PER calculating unit 27 also stores a signal reception schedule in which, for example, one signal is scheduled to be received every 30 minutes. The PER calculating unit 27 is equipped with a clock.

From the result of determination stored in the PER storage unit 24 as described above, the PER calculating unit 27 obtains, at predetermined intervals, the number of signals properly received in the past T2 seconds and the number of properly received signals corresponding to N2 signals scheduled to be received. Then, the PER calculating unit 27 determines whether the number of signals properly received in the past T2 seconds is less than or equal to the threshold value M3. The PER calculating unit 27 also determines whether the number of properly received signals corresponding to the N2 signals scheduled to be received is less than or equal to the threshold value M4. If the number of signals properly received in the past T2 seconds is less than or equal to the threshold value M3, or if the number of properly received signals corresponding to the N2 signals scheduled to be received is less than or equal to the threshold value M4, the PER calculating unit 27 determines that the PER has deteriorated. This determination is equivalent to determining whether the number of received signals determined to be abnormal is greater than or equal to a threshold value. In other words, the PER calculating unit 27 determines whether the PER is greater than or equal to a predetermined threshold value.

If determining that the PER has deteriorated, the PER calculating unit 27 outputs a PHY switching request to the PHY control unit 23.

The PHY-schedule storage unit 26 stores an initial PHY schedule in advance. Here, the initial PHY schedule refers to a PHY schedule used for the first time before any change is made. In the first embodiment, the initial PHY schedule is stored in advance in the PHY-schedule storage unit 26. Alternatively, for example, the initial PHY schedule may be received from the base station apparatus 1 and stored in the PHY-schedule storage unit 26.

The PHY-schedule storage unit 26 receives a changed PHY schedule from the data processing unit 22 and stores the received PHY schedule. The PHY schedule stored in the PHY-schedule storage unit 26 is updated each time a PHY schedule is transmitted from the base station apparatus 1. The PHY-schedule storage unit 26 is an example of “second schedule storage unit”.

The PHY control unit 23 receives input of a PHY switching request from the data processing unit 22. If the PER calculating unit 27 determines that the PER has deteriorated, the PHY control unit 23 receives a PHY switching request from the PER calculating unit 27.

In response to the PHY switching request, the PHY control unit 23 requests the transmission of synchronization timing from the time managing unit 25. The PHY control unit 23 obtains the synchronization timing from the time managing unit 25. Also, the PHY control unit 23 obtains a PHY schedule from the PHY-schedule storage unit 26. On the basis of the synchronization timing obtained from the time managing unit 25, the PHY control unit 23 counts the time before the start of communication using a specified PHY described in the PHY schedule. Then, the PHY control unit 23 outputs information on PHY 2 and a schedule for communication using PHY 2 to the radio communication unit 21. The PHY control unit 23 is an example of “second set value switching unit”.

From the data processing unit 22, the time managing unit 25 obtains a synchronization packet added to a signal transmitted from the base station apparatus 1. The radio communication unit 21 uses the synchronization packet to obtain and store the synchronization timing of communication. For example, during communication using PHY 1, the radio communication unit 21 uses the synchronization packet to obtain and store the start timing of communication using PHY 1. Then, the time managing unit 25 receives a request for synchronization timing from the PHY control unit 23. The time managing unit 25 notifies the PHY control unit 23 of the latest synchronization timing.

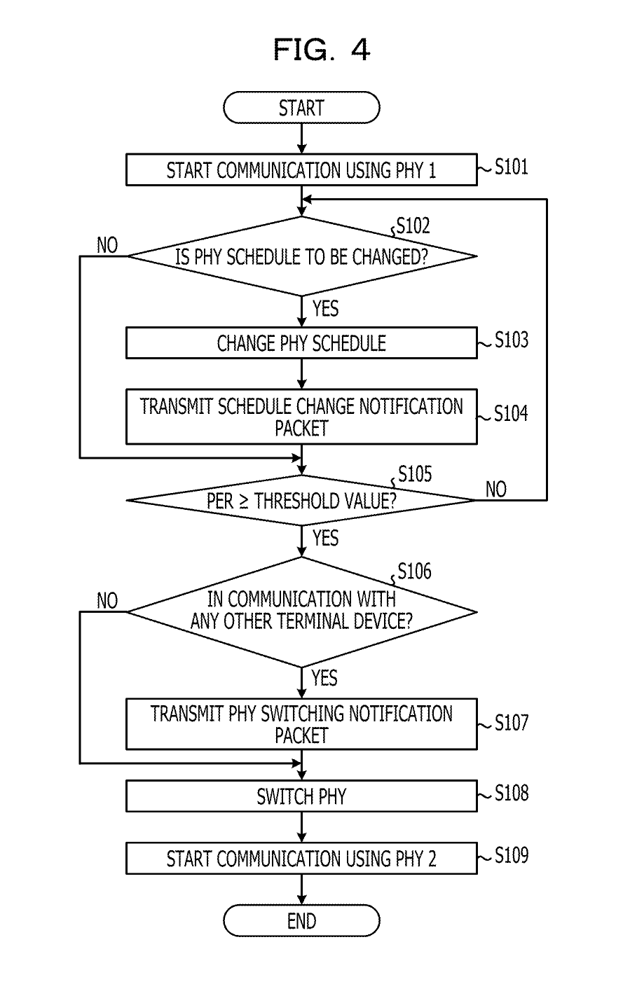

A flow of a PHY switching process in the base station apparatus 1 according to the first embodiment will now be described with reference to FIG. 4. FIG. 4 is a flowchart of a PHY switching process in the base station apparatus 1 according to the first embodiment. A description will be given of a process of switching from communication using PHY 1 to communication using PHY 2.

In accordance with a schedule for communication using PHY 1 described in a PHY schedule, the radio communication unit 11 starts communicating with the terminal apparatus 2 using PHY 1 (step S101).

The schedule-switching determining unit 13 of the base station apparatus 1 obtains, from the data processing unit 12, information indicating the condition of communication with the terminal apparatus 2. Depending on whether the condition of communication with the terminal apparatus 2 satisfies a change condition, the schedule-switching determining unit 13 determines whether the PHY schedule is to be changed (step S102). If the schedule-switching determining unit 13 determines that the PHY schedule is not to be changed (NO in step S102), the process proceeds to step S105.

On the other hand, if determining that the PHY schedule is to be changed (YES in step S102), the schedule-switching determining unit 13 outputs, to the switching-notification control unit 18, an instruction to switch the PHY schedule, as well as changes to be made to the PHY schedule. In response to the instruction to switch the PHY schedule from the schedule-switching determining unit 13, the switching-notification control unit 18 changes the PHY schedule stored in the PHY-schedule storage unit 16 to reflect the changes as instructed (step S103).

Next, the switching-notification control unit 18 creates a schedule change notification packet which contains information on the PHY schedule changed in step S103. The switching-notification control unit 18 then outputs the schedule change notification packet to the data processing unit 12. The data processing unit 12 obtains the schedule change notification packet from the switching-notification control unit 18 and transmits it through the radio communication unit 11 and the antenna to the terminal apparatus 2 (step S104). The PER calculating unit 17 calculates a PER in the communication with the terminal apparatus 2. For the calculation, the PER calculating unit 17 uses a result of determination as to whether a signal transmitted from the terminal apparatus 2 has been properly received, the result being stored in the PER storage unit 15. The PER calculating unit 17 then determines whether the calculated PER is greater than or equal to a threshold value stored in advance (step S105). Specifically, the PER calculating unit 17 determines whether the number of signals properly received in the past T¹ seconds is less than or equal to the threshold value M1, or whether the number of properly received signals corresponding to the N1 signals scheduled to be received is less than or equal to the threshold value M2. If the PER is less than the threshold value (NO in step S105), the process returns to step S102, where the radio communication unit 11 continues to communicate using PHY 1.

On the other hand, if the PER is greater than or equal to the threshold value (YES in step S105), the switching-notification control unit 18 determines whether the terminal apparatus 2 is in communication with one or both of the terminal apparatus 3 and the terminal apparatus 4 (step S106). If the switching-notification control unit 18 determines that the terminal apparatus 2 is not in communication with either of the terminal apparatus 3 and the terminal apparatus 4 (NO in step S106), the process proceeds to step S108.

If the terminal apparatus 2 is in communication with one or both of the terminal apparatus 3 and the terminal apparatus 4 (YES in step S106), the switching-notification control unit 18 creates a PHY switching notification packet. Then, the switching-notification control unit 18 outputs information on the terminal apparatus (or devices) with which the terminal apparatus 2 is in communication and the PHY switching notification packet to the data processing unit 12. The data processing unit 12 transmits the PHY switching notification packet through the radio communication unit 11 and the antenna to the terminal apparatus (or devices) with which the terminal apparatus 2 is in communication (step S107).

The PER calculating unit 17 outputs, to the PHY control unit 14, a PHY switching request for switching the PHY used in the communication. The PHY control unit 14 receives input of the PHY switching request from the PER calculating unit 17. The PHY control unit 14 identifies PHY 2 as a PHY placed after PHY 1 in the order of use. From the PHY schedule stored in the PHY-schedule storage unit 16, the PHY control unit 14 obtains the start and end timing of communication using PHY 2. The PHY control unit 14 outputs information on PHY 2 and the start and end timing of communication using PHY 2 to the radio communication unit 11. The radio communication unit 11 makes settings such that communication using PHY 2 can be performed in accordance with the schedule for the communication using PHY 2. The radio communication unit 11 then switches the PHY used in the communication (step S108).

In accordance with the schedule for the communication using PHY 2, the radio communication unit 11 starts communicating with the terminal apparatus 2 using PHY 2 (step S109).

For convenience of description, FIG. 4 illustrates the process as if the schedule change operation is followed by the PHY switching operation. In practice, however, the schedule change operation and the PHY switching operation are performed in parallel.

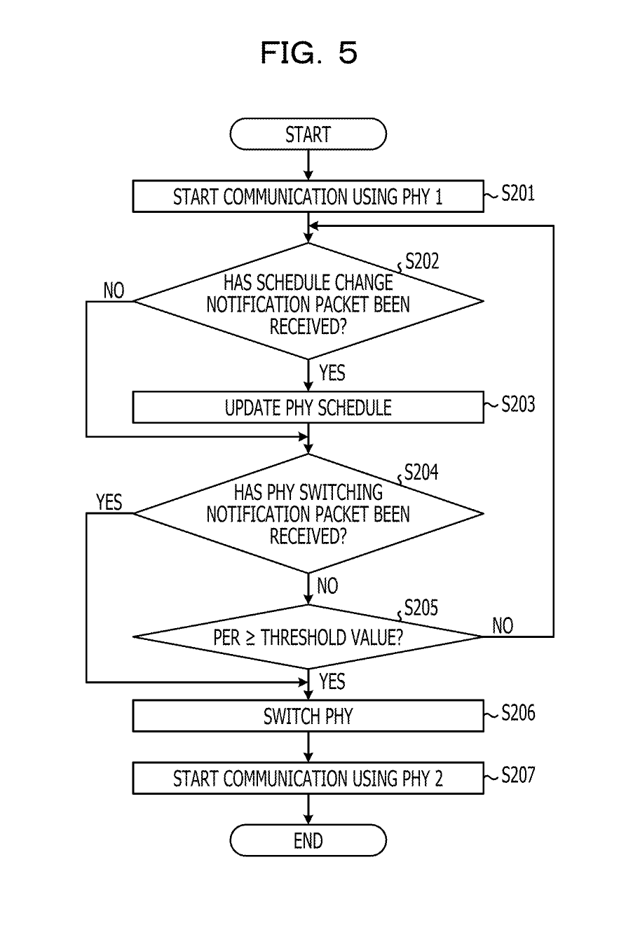

A flow of a PHY switching process in the terminal apparatus 2 will now be described with reference to FIG. 5. FIG. 5 is a flowchart of a PHY switching process in the terminal apparatus 2 according to the first embodiment. A description will be given of a process of switching from communication using PHY 1 to communication using PHY 2.

In accordance with a schedule for communication using PHY 1 described in a PHY schedule, the radio communication unit 21 starts communicating with the base station apparatus 1 using PHY 1 (step S201).

The data processing unit 22 determines whether a schedule change notification packet has been received (step S202). If the data processing unit 22 determines that the schedule change notification packet has not been received (NO in step S202), the process proceeds to step S204.

On the other hand, if the schedule change notification packet has been received (YES in step S202), the data processing unit 22 obtains a changed PHY schedule from the schedule change notification packet. The data processing unit 22 then updates the PHY schedule stored in the PHY-schedule storage unit 26 with the changed PHY schedule (step S203).

The data processing unit 22 also determines whether a PHY switching notification packet has been received (step S204). If the PHY switching notification packet has not been received (NO in step S204), the PER calculating unit 27 calculates a PER in the communication with the base station apparatus 1. For the calculation, the PER calculating unit 27 uses a result of determination as to whether a signal transmitted from the base station apparatus 1 has been properly received, the result being stored in the PER storage unit 24. The PER calculating unit 27 then determines whether the calculated PER is greater than or equal to a threshold value stored in advance (step S205). Specifically, the PER calculating unit 27 determines whether the number of signals properly received in the past T2 seconds is less than or equal to the threshold value M3, or whether the number of properly received signals corresponding to the N2 signals scheduled to be received is less than or equal to the threshold value M4. If the PER is less than the threshold value (NO in step S205), the process returns to step S202, where the radio communication unit 21 continues to communicate using PHY 1.

If the PHY switching notification packet has been received (YES in step S204) or if the PER is greater than or equal to the threshold value (YES in step S205), the PER calculating unit 27 outputs, to the PHY control unit 23, a PHY switching request for switching the PHY used in the communication. The PHY control unit 23 receives input of the PHY switching request from the PER calculating unit 27. The PHY control unit 23 identifies PHY 2 as a PHY placed after PHY 1 in the order of use. From the PHY schedule stored in the PHY-schedule storage unit 26, the PHY control unit 23 obtains the start and end timing of communication using PHY 2. The PHY control unit 23 also obtains the latest synchronization timing stored in the time managing unit 25. The PHY control unit 23 outputs information on PHY 2 and the start and end timing of communication using PHY 2 to the radio communication unit 21. The radio communication unit 21 makes settings such that communication using PHY 2 can be performed in accordance with the schedule for the communication using PHY 2. The radio communication unit 21 then switches the PHY used in the communication (step S206).

In accordance with the schedule for the communication using PHY 2, the radio communication unit 21 starts communicating with the base station apparatus 1 using PHY 2 (step S207).

For convenience of description, FIG. 5 illustrates the process as if the schedule change operation is followed by the PHY switching operation. In practice, however, the schedule change operation and the PHY switching operation are performed in parallel.

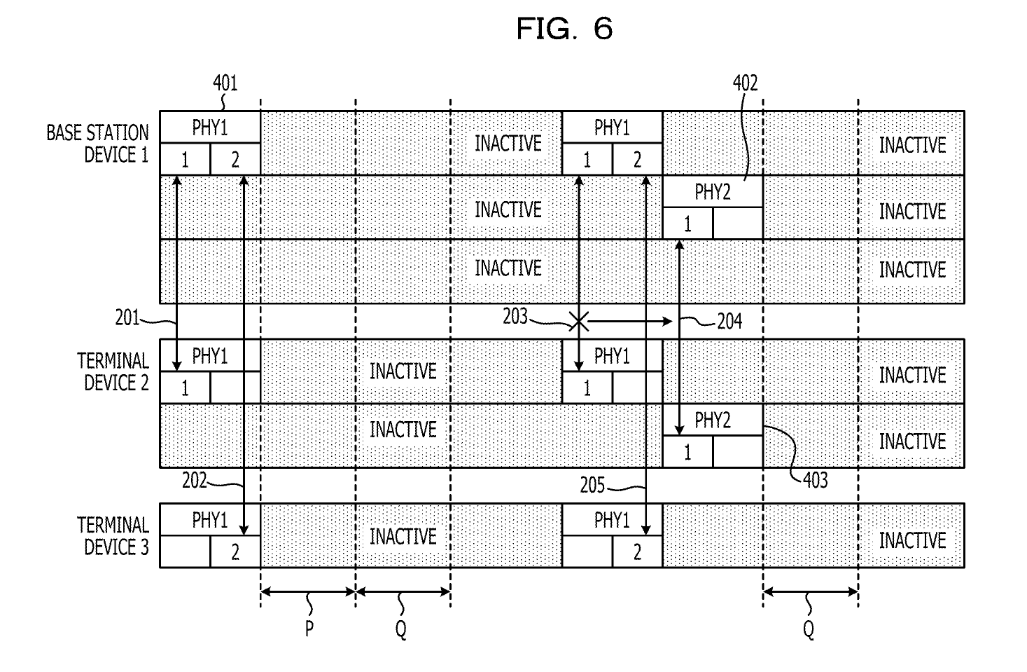

PHY switching in the radio communication system according to the first embodiment will now be described with reference to FIG. 6. FIG. 6 illustrates PHY switching in the radio communication system according to the first embodiment. A description will be given of a process which starts in a state where the base station apparatus 1 is in communication with the terminal apparatus 2 and the terminal apparatus 3 using PHY 1. In FIG. 6, time elapses from left to right.

As illustrated, a schedule for communication using each PHY is divided into time slots, each of which is allocated to a different terminal apparatus. For example, a schedule 401 is divided into a time slot for communicating with the terminal apparatus 2 and a time slot for communicating with the terminal apparatus 3. A region indicated as “Inactive” in FIG. 6 represents a period during which no communication is possible.

In the first embodiment, the base station apparatus 1 first makes settings only for communication using PHY 1 in accordance with the schedule 401. Then, the base station apparatus 1 performs communication using PHY 1 in accordance with the schedule 401. Although periods indicated by P and Q are reserved for communication using PHY 2 and PHY 3, the base station apparatus 1 does not make any settings for communication using PHY 2 and PHY 3 during the periods P and Q.

As indicated by reference numeral 201, the base station apparatus 1 and the terminal apparatus 2 are in communication using PHY 1. As indicated by reference numeral 202, the base station apparatus 1 and the terminal apparatus 3 are in communication using PHY 1.

Assume that during communication using PHY 1, the condition of communication using PHY 1 between the base station apparatus 1 and the terminal apparatus 2 deteriorates as indicated by reference numeral 203. In this case, the base station apparatus 1 creates a new schedule 402 for communication using PHY 2. Then, the base station apparatus 1 performs communication using PHY 1 and PHY 2 in accordance with the schedules for communication using PHY 1 and PHY 2. Although a period indicated by Q is reserved for communication using PHY 3, the base station apparatus 1 has not yet created any schedule for communication using PHY 3. The terminal apparatus 2 switches communication settings in accordance with a schedule 403 for communication using PHY 2.

Then, as indicated by reference numeral 204, communication using PHY 2 starts between the base station apparatus 1 and the terminal apparatus 2. At this point, the terminal apparatus 3 is in a good communication condition and is not in communication with the terminal apparatus 2. Therefore, as indicated by reference numeral 205, the terminal apparatus 3 is in communication with the base station apparatus 1 using PHY 1. For example, if the terminal apparatus 3 and the terminal apparatus 2 are in communication with each other, the terminal apparatus 3 receives a PHY switching notification packet from the base station apparatus 1 and communicates with the base station apparatus 1 using PHY 2.

As described above, in the radio communication system according to the first embodiment, the base station apparatus 1 and the terminal apparatuses 2 and 3 each have a PHY schedule time-multiplexed for communication using each PHY. The base station apparatus 1 and the terminal apparatuses 2 and 3 perform communication using each PHY in accordance with the PHY schedule. Therefore, even if the condition of communication using one PHY deteriorates, switching to communication using another PHY can be done in a short time. Moreover, since communication using each PHY is not performed during periods other than the periods allocated in the PHY schedule, it is possible to reduce power consumption during the period before switching of communication.

### Second Embodiment

A radio communication system according to a second embodiment will now be described. The radio communication system of the second embodiment is different from that of the first embodiment in that a schedule for communication using each PHY is created in the PHY schedule in advance, so that the base station apparatus 1 is ready for communication using each PHY in accordance with the schedule. The base station apparatus 1 of the second embodiment is the same as that illustrated in the block diagram of FIG. 2. The terminal apparatus 2 of the second embodiment is also the same as that illustrated in the block diagram of FIG. 3. Unless otherwise specified, components denoted by the same reference numerals in the first and second embodiments have the same functions.

The PHY control unit 14 of the base station apparatus 1 according to the second embodiment obtains schedules for all PHYs described in the PHY schedule stored in the PHY-schedule storage unit 16. Here, PHY 1 to PHY 3 will be described as the PHYs. That is, the PHY control unit 14 obtains schedules for communication using PHY 1 to PHY 3. Then, the PHY control unit 14 transmits information on PHY 1 and the schedule for communication using PHY 1 to the radio communication unit 11. The PHY control unit 14 also transmits information on PHY 2 and the schedule for communication using PHY 2 to the radio communication unit 11. The PHY control unit 14 also transmits information on PHY 3 and the schedule for communication using PHY 3 to the radio communication unit 11.

Thus, in the second embodiment, where information and schedules for all PHYs to be used are transmitted to the radio communication unit 11, the PHY control unit 14 does not have to store the order of use of PHYs.

The radio communication unit 11 obtains information on PHY 1 to PHY 3 and the schedules for communication using PHY 1 to PHY 3. Then, the radio communication unit 11 makes settings such that communication using PHY 1 can be performed in accordance with the schedule for PHY 1. The radio communication unit 11 also makes settings such that communication using PHY 2 can be performed in accordance with the schedule for PHY 2. The radio communication unit 11 also makes settings such that communication using PHY 3 can be performed in accordance with the schedule for PHY 3. Thus, in the second embodiment, regardless of the condition of communication with the terminal apparatus (or devices) with which the base station apparatus 1 is in communication, the radio communication unit 11 of the base station apparatus 1 makes settings such that communication using each PHY can be performed in accordance with the time-multiplexed schedule. Therefore, when communication using any of PHY 1 to PHY 3 is performed in accordance with the schedule, the radio communication unit 11 can communicate with the terminal apparatus 2.

The PER calculating unit 17 calculates a PER in the communication with the terminal apparatus 2. For the calculation, the PER calculating unit 17 uses a result of determination as to whether a signal transmitted from the terminal apparatus 2 has been properly received, the result being stored in the PER storage unit 15. The PER calculating unit 17 then determines whether the communication condition has deteriorated, depending on whether the number of signals properly received in the past T1 seconds is less than or equal to the threshold value M1, or whether the number of properly received signals corresponding to the N1 signals scheduled to be received is less than or equal to the threshold value M2. If the communication condition has deteriorated, the PER calculating unit 17 notifies the switching-notification control unit 18 that the condition of communication with the terminal apparatus 2 has deteriorated. In the second embodiment, where the PHY control unit 14 outputs information on each PHY and a schedule for communication using the PHY to the radio communication unit 11, the PER calculating unit 17 does not have to output a PHY switching request to the PHY control unit 14.

The terminal apparatus 2 of the second embodiment is the same as that of the first embodiment. Specifically, the PHY control unit 23 of the terminal apparatus 2 stores the order of use of PHYs. When the terminal apparatus 2 starts communicating with the base station apparatus 1, the PHY control unit 23 transmits information on PHY 1 placed first in the order of use and the schedule for communication using PHY 1 to the radio communication unit 21. In this case, the radio communication unit 21 communicates with the base station apparatus 1 using PHY 1 in accordance with the schedule for communication using PHY 1.

The PHY control unit 23 receives input of a PHY switching request from the data processing unit 22 or from the PER calculating unit 27. In response to the PHY switching request, the PHY control unit 23 obtains synchronization timing from the time managing unit 25. The PHY control unit 23 also obtains a PHY schedule from the PHY-schedule storage unit 26. On the basis of the synchronization timing obtained from the time managing unit 25, the PHY control unit 23 counts the time before the start of communication using a specified PHY described in the PHY schedule. Then, the PHY control unit 23 outputs information on PHY 2 and the start and end timing of communication using PHY 2 to the radio communication unit 21. In this case, the radio communication unit 21 communicates with the base station apparatus 1 using PHY 2 in accordance with the schedule for communication using PHY 2.

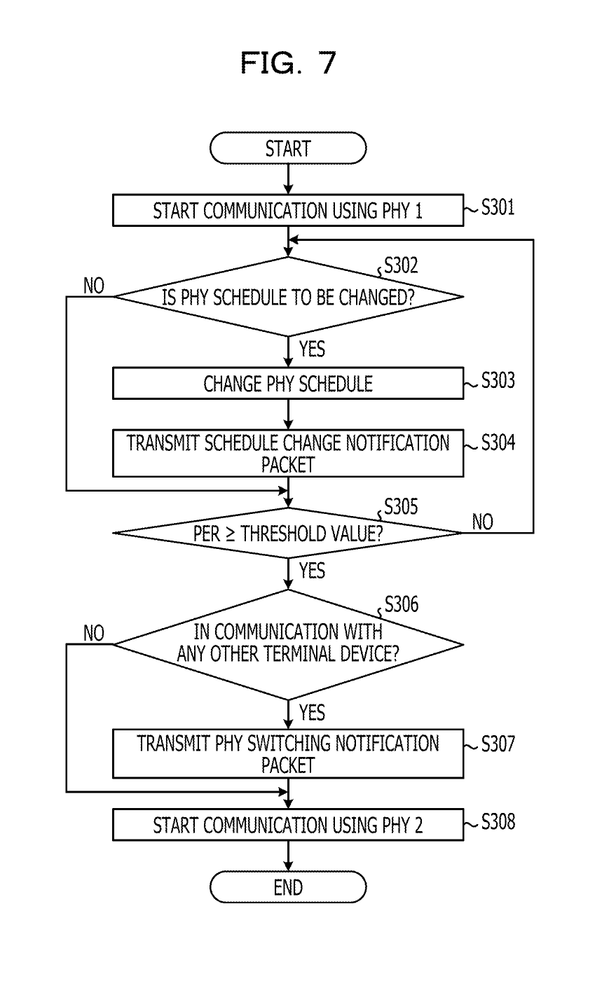

A flow of a PHY switching process in the base station apparatus 1 according to the second embodiment will now be described with reference to FIG. 7. FIG. 7 is a flowchart of a PHY switching process in the base station apparatus 1 according to the second embodiment. A description will be given of a process of switching from communication using PHY 1 to communication using PHY 2. Here, PHY 1 to PHY 3 will be described as PHYs to be used.

In accordance with a schedule for communication using PHY 1 described in a PHY schedule, the radio communication unit 11 starts communicating with the terminal apparatus 2 using PHY 1 (step S301). At the same time, the radio communication unit 11 makes settings for communication using PHY 2 and PHY 3 in accordance with schedules.

The schedule-switching determining unit 13 of the base station apparatus 1 obtains, from the data processing unit 12, information indicating the condition of communication with the terminal apparatus 2. Depending on whether the condition of communication with the terminal apparatus 2 satisfies a change condition, the schedule-switching determining unit 13 determines whether the PHY schedule is to be changed (step S302). If the schedule-switching determining unit 13 determines that the PHY schedule is not to be changed (NO in step S302), the process proceeds to step S305.

On the other hand, if determining that the PHY schedule is to be changed (YES in step S302), the schedule-switching determining unit 13 outputs, to the switching-notification control unit 18, an instruction to switch the PHY schedule, as well as changes to be made to the PHY schedule. In response to the instruction to switch the PHY schedule from the schedule-switching determining unit 13, the switching-notification control unit 18 changes the PHY schedule stored in the PHY-schedule storage unit 16 to reflect the changes as instructed (step S303).

Next, the switching-notification control unit 18 creates a schedule change notification packet which contains information on the PHY schedule changed in step S303. The switching-notification control unit 18 then outputs the schedule change notification packet to the data processing unit 12. The data processing unit 12 obtains the schedule change notification packet from the switching-notification control unit 18 and transmits it through the radio communication unit 11 and the antenna to the terminal apparatus 2 (step S304).

The PER calculating unit 17 calculates a PER in the communication with the terminal apparatus 2. For the calculation, the PER calculating unit 17 uses a result of determination as to whether a signal transmitted from the terminal apparatus 2 has been properly received, the result being stored in the PER storage unit 15. The PER calculating unit 17 then determines whether the calculated PER is greater than or equal to a threshold value stored in advance (step S305). Specifically, the PER calculating unit 17 determines whether the number of signals properly received in the past T1 seconds is less than or equal to the threshold value M1, or whether the number of properly received signals corresponding to the N1 signals scheduled to be received is less than or equal to the threshold value M2. If the PER is less than the threshold value (NO in step S305), the process returns to step S302, where the radio communication unit 11 continues to communicate using PHY 1.

On the other hand, if the PER is greater than or equal to the threshold value (YES in step S305), the switching-notification control unit 18 determines whether the terminal apparatus 2 is in communication with one or both of the terminal apparatus 3 and the terminal apparatus 4 (step S306). If the switching-notification control unit 18 determines that the terminal apparatus 2 is not in communication with either of the terminal apparatus 3 and the terminal apparatus 4 (NO in step S306), the process proceeds to step S308.

If the terminal apparatus 2 is in communication with one or both of the terminal apparatus 3 and the terminal apparatus 4 (YES in step S306), the switching-notification control unit 18 creates a PHY switching notification packet. Then, the switching-notification control unit 18 outputs information on the terminal apparatus (or devices) with which the terminal apparatus 2 is in communication and the PHY switching notification packet to the data processing unit 12. The data processing unit 12 transmits the PHY switching notification packet through the radio communication unit 11 and the antenna to the terminal apparatus (or devices) with which the terminal apparatus 2 is in communication (step S307).

In accordance with the schedule for communication using PHY 2, the radio communication unit 11 starts communicating with the terminal apparatus 2 using PHY 2 (step S308). At the same time, the radio communication unit 11 makes settings for communication using PHY 1 and PHY 3 in accordance with their schedules.

For convenience of description, FIG. 7 illustrates the process as if the schedule change operation is followed by the PHY switching operation. In practice, however, the schedule change operation and the PHY switching operation are performed in parallel.

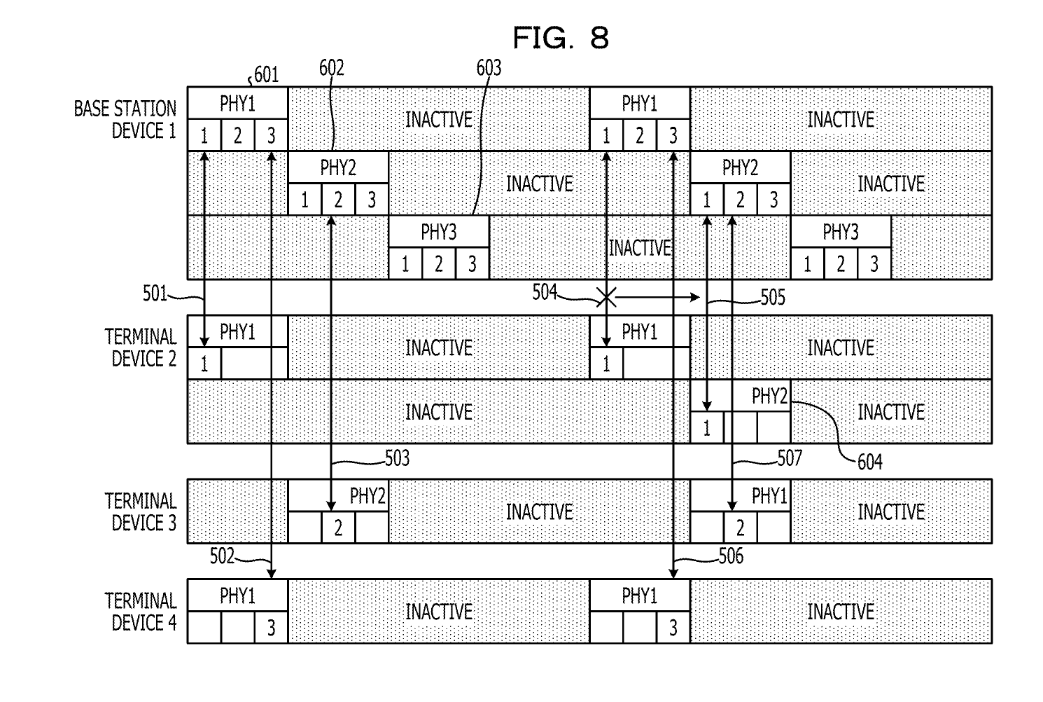

PHY switching in the radio communication system according to the second embodiment will now be described with reference to FIG. 8. FIG. 8 illustrates PHY switching in the radio communication system according to the second embodiment. A description will be given of a process which starts in a state where the base station apparatus 1 is in communication with the terminal apparatus 2 and the terminal apparatus 4 using PHY 1, and is in communication with the terminal apparatus 3 using PHY 2. In FIG. 8, time elapses from left to right.

As illustrated, a schedule for communication using each PHY is divided into time slots, each of which is allocated to a different terminal apparatus. For example, a schedule 601, a schedule 602, and a schedule 603 each are divided into a time slot for communicating with the terminal apparatus 2, a time slot for communicating with the terminal apparatus 3, and a time slot for communicating with the terminal apparatus 4. A region indicated as “Inactive” in FIG. 8 represents a period during which no communication is possible.

In the second embodiment, the base station apparatus 1 makes settings for communication using PHYs 1, 2, and 3 in accordance with the schedules 601, 602, and 603, respectively.

As indicated by reference numeral 501, the base station apparatus 1 and the terminal apparatus 2 are in communication using PHY 1. As indicated by reference numeral 502, the base station apparatus 1 and the terminal apparatus 4 are in communication using PHY 1. As indicated by reference numeral 503, the base station apparatus 1 and the terminal apparatus 3 are in communication using PHY 2.

Assume that during communication using PHY 1, the condition of communication using PHY 1 between the base station apparatus 1 and the terminal apparatus 2 deteriorates as indicated by reference numeral 504. In this case, the base station apparatus 1 makes communication settings in accordance with the schedules for communication using PHY 1 to PHY 3 in the same manner as before.

The terminal apparatus 2 switches communication settings in accordance with a schedule 604 for communication using PHY 2.

Then, as indicated by reference numeral 505, communication using PHY 2 starts between the base station apparatus 1 and the terminal apparatus 2. At this point, the terminal apparatus 4 is in a good communication condition and is not in communication with the terminal apparatus 2. Therefore, as indicated by reference numeral 506, the terminal apparatus 4 is in communication with the base station apparatus 1 using PHY 1. For example, if the terminal apparatus 4 and the terminal apparatus 2 are in communication with each other, the terminal apparatus 4 receives a PHY switching notification packet from the base station apparatus 1 and communicates with the base station apparatus 1 using PHY 2. As indicated by reference numeral 507, the terminal apparatus 3 is in communication with the base station apparatus 1 using PHY 2 in the same manner as before.

As described above, in the radio communication system according to the second embodiment, the base station apparatus 1 makes settings for communication using each PHY in accordance with a PHY schedule time-multiplexed for communication using each PHY, so that communication using each PHY can be performed. Thus, when a terminal apparatus switches the PHY and starts communication, the terminal apparatus can reliably communicate with the base station apparatus 1. Therefore, in the radio communication system according to the second embodiment, the time to resume communication after PHY switching can be reduced, as compared to that in the first embodiment.

Hardware Configuration

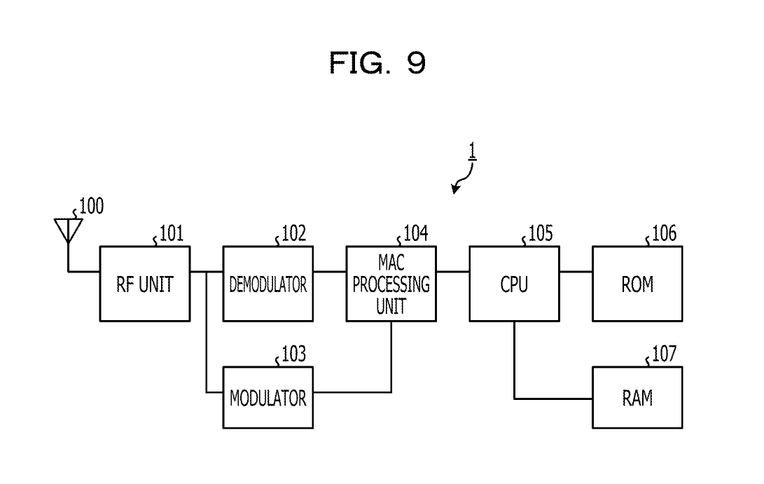

Hardware configurations of a base station apparatus and a terminal apparatus will now be described. FIG. 9 illustrates a hardware configuration of the base station apparatus 1. As illustrated in FIG. 9, the base station apparatus 1 according to the embodiments includes an antenna 100, a radio frequency (RF) unit 101, a demodulator 102, a modulator 103, a media access control (MAC) processing unit 104, a central processing unit (CPU) 105, a read only memory (ROM) 106, and a random access memory (RAM) 107.

The RF unit 101 corresponds to, for example, the radio communication unit 11 illustrated in FIG. 2. The demodulator 102, the modulator 103, and the MAC processing unit 104 correspond to, for example, part of the function of the data processing unit 12 illustrated in FIG. 2.

The CPU 105 and the ROM 106 implement, for example, the functions of the data processing unit 12, the schedule-switching determining unit 13, the PHY control unit 14, the PER calculating unit 17, and the switching-notification control unit 18 illustrated in FIG. 2. For example, the ROM 106 stores various programs that implement processing in the data processing unit 12, the schedule-switching determining unit 13, the PHY control unit 14, the PER calculating unit 17, and the switching-notification control unit 18 illustrated in FIG. 2. By reading and executing the various programs, the CPU 105 generates processes for implementing the functions described above. The ROM 106 also stores algorithms for processing performed at upper layers, such as the application layer and others. Examples of the processing performed at upper layers include displaying on a display device and stopping an operation. The RAM 107 corresponds to the PER storage unit 15 and the PHY-schedule storage unit 16 illustrated in FIG. 2.

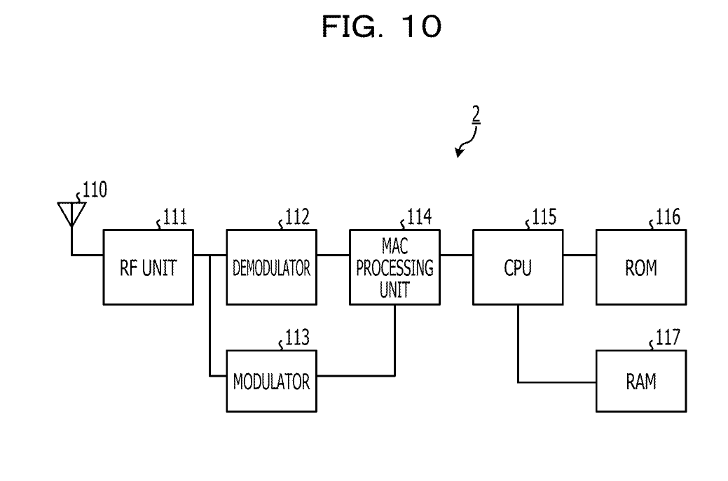

FIG. 10 illustrates a hardware configuration of the terminal apparatus 2. As illustrated in FIG. 10, the terminal apparatus 2 according to the embodiments includes an antenna 110, an RF unit 111, a demodulator 112, a modulator 113, a MAC processing unit 114, a CPU 115, a ROM 116, and a RAM 117.

The RF unit 111 corresponds to, for example, the radio communication unit 21 illustrated in FIG. 3. The demodulator 112, the modulator 113, and the MAC processing unit 114 correspond to, for example, part of the function of the data processing unit 22 illustrated in FIG. 3.

The CPU 115 and the ROM 116 implement, for example, the functions of the data processing unit 22, the PHY control unit 23, the time managing unit 25, and the PER calculating unit 27 illustrated in FIG. 3. For example, the ROM 116 stores various programs that implement processing in the data processing unit 22, the PHY control unit 23, the time managing unit 25, and the PER calculating unit 27 illustrated in FIG. 3. By reading and executing the various programs, the CPU 115 generates processes for implementing the functions described above. The ROM 116 also stores algorithms for processing performed at upper layers, such as the application layer and others. Examples of the processing performed at upper layers include displaying on a display device, stopping an operation, and transmitting emergency data to the base station apparatus 1. The RAM 117 corresponds to the PER storage unit 24 and the time managing unit 25 illustrated in FIG. 3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication system comprising:
a base station apparatus including
a first memory configured to store a schedule for communication using each of a plurality of set values of a predetermined communication element in the physical layer,
a first antenna configured to communicate with a terminal apparatus using a first set value of the plurality of set values in accordance with the schedule stored in the first memory, and
a first processor configured to select a second set value of the plurality of set values if the condition of communication performed with the terminal apparatus by the first antenna using the first set value has deteriorated, and cause the first antenna to perform communication using the selected second set value in accordance with the schedule; and
the terminal apparatus including
a second memory configured to store the schedule,
a second antenna configured to communicate with the base station apparatus using the first set value in accordance with the schedule stored in the second memory, and
a second processor configured to select the second set value if the condition of communication performed with the base station apparatus by the second antenna using the first set value has deteriorated, and cause the second antenna to perform communication using the selected second set value in accordance with the schedule.

2. The radio communication system according to claim 1, wherein the first processor is further configured
to change the schedule on the basis of the condition of communication with the terminal apparatus, and
to transmit, if the schedule has been changed, the changed schedule to the terminal apparatus; and
to update the stored schedule with the changed schedule.

3. The radio communication system according to the claim 1, wherein the first memory and the second memory store a schedule in which communication using one of the plurality of set values does not coincide with communication using another of the plurality of set values.

4. The radio communication system according to the claim 1, wherein during communication using the first set value, the first processor makes communication settings which allow communication using each of the plurality of set values in accordance with the schedule; and
in response to selecting the second set value, the first antenna performs communication using the second set value on the basis of the communication settings.

5. The radio communication system according to the claim 1, wherein in response to selecting the second set value, the first processor makes communication settings which allow communication using the second set value, and the first antenna performs communication using the second set value on the basis of the communication settings.

6. The radio communication system according to the claim 1, wherein the first processor is further configured to identify, if the condition of communication performed with the terminal apparatus by the first antenna using the first set value has deteriorated, another terminal apparatus with which the terminal apparatus is in communication using the first set value, and notify the identified terminal apparatus to switch to communication using the second set value.

7. A base station apparatus comprising:
a memory configured to store a schedule for communication using each of a plurality of set values of a predetermined communication element in the physical layer;
a antenna configured to communicate with a terminal apparatus using a set value of the plurality of set values in accordance with the schedule stored in the memory; and
a processor configured to select a second set value of the plurality of set values if the condition of communication performed with the terminal apparatus by the antenna using the set value has deteriorated, and cause the antenna to perform communication using the selected second set value in accordance with the schedule.

8. A terminal apparatus comprising:
a memory configured to store the schedule for communication using each of a plurality of set values of a predetermined communication element in the physical layer;
a antenna configured to communicate with the base station apparatus using the first set value in accordance with the schedule stored in the memory; and
a processor configured to select the set value if the condition of communication performed with the base station apparatus by the antenna using the first set value has deteriorated, and cause the antenna to perform communication using the selected set value in accordance with the schedule.
